(19) United States
(12) Patent Application Publication
(10) Pub. No.: US 2026/0278324 A1
(43) Pub. Date: Sep. 17, 2026

(54) IMAGE PROCESSING MECHANISM

(71) Applicants: Walter F. Kailey, Boulder, CO (US); Claudiu Attila Balogh, Timisoara (RO); Bogdan Lile, Timisoara (RO)

(72) Inventors: Walter F. Kailey, Boulder, CO (US); Claudiu Attila Balogh, Timisoara (RO); Bogdan Lile, Timisoara (RO)

(73) Assignee: Ricoh Company, Ltd., Tokyo (JP)

(21) Appl. No.: 19/077,795

(22) Filed: Mar. 12, 2025

(51) Int. Cl. G06K 15/02

(52) U.S. Cl. CPC G06K 15/1859; G06K 15/1881

(57) ABSTRACT

A system is disclosed. The system includes a first processor to divide an image into a plurality of stripe image component, determine assignments for each of the plurality of stripe image components to one of a plurality of tile groups, perform a first processing on the stripe image components, assemble the first processed stripe image components into the plurality of tile groups according to the assignments, transmit the plurality of tile groups, receive processed tile groups, assemble the processed tile groups into a processed image; and a second processor to perform a second processing on each of the plurality of tile groups to generate processed tile groups.

### FIELD OF THE INVENTION

The invention relates to the field of printing systems, and in particular, to perform parallel image processing.

### BACKGROUND

In commercial and transactional printers, various image processing applications may be performed to process sheetside print data.

### SUMMARY

In one embodiment, a system is disclosed. The system includes a system a first processor to divide an image into a plurality of stripe image component, determine assignments for each of the plurality of stripe image components to one of a plurality of tile groups, perform a first processing on the stripe image components, assemble the first processed stripe image components into the plurality of tile groups according to the assignments, transmit the plurality of tile groups, receive processed tile groups, assemble the processed tile groups into a processed image; and a second processor to perform a second processing on each of the plurality of tile groups to generate processed tile groups.

### BRIEF DESCRIPTION OF THE DRAWINGS

A better understanding of the present invention can be obtained from the following detailed description in conjunction with the following drawings, in which:

FIG. 1 is a block diagram of one embodiment of a printing system;

FIG. 2 is a block diagram illustrating one embodiment of a print controller;

FIG. 3 illustrates one embodiment of a sheetside processing mechanism;

FIG. 4A illustrates one embodiment of a task queue;

FIG. 4B illustrates one embodiment of processing threads;

FIG. 4C illustrates one embodiment of a print image divided into stipes

FIG. 5 illustrates one embodiment of compute resources;

FIG. 6A illustrates another embodiment of a sheetside processing mechanism;

FIG. 6B illustrates yet another embodiment of a sheetside processing mechanism;

FIG. 6C illustrates still another embodiment of a sheetside processing mechanism;

FIG. 7 is a flow diagram illustrating one embodiment for processing sheetside images;

FIG. 8 illustrates one embodiment stripe image components in tile groups;

FIG. 9 is a flow diagram illustrating one embodiment of a process for generating a set of stripe image components;

FIG. 10 is a flow diagram illustrating one embodiment of a process for generating processed tile groups of stripe image components;

FIG. 11 is a flow diagram illustrating one embodiment of a process for generating a second processing resource group;

FIG. 12 is a flow diagram illustrating one embodiment of a process for generating second processed tile groups;

FIG. 13 is a flow diagram illustrating one embodiment of non-uniform stripe image component processing; and

FIG. 14 illustrates one embodiment of a computer system.

### DETAILED DESCRIPTION

Image processing applications may implement a scalable parallel processing pipeline using heterogenous platforms to process images. For instance, decryption and decompression of images followed by halftoning may be performed at a host processor, while additional processing performed on the images, such as edge enhancement, may be performed at a satellite processing platform due to computational intensity. Further, the additional processing by the satellite processor may be more efficiently performed with a different type processor than the host's processor (e.g., GPU versus CPU).

However, complex processing stages are typically initialized differently, with large data sets being transferred from one processor to another at the end of each stage. Further, image data stripes (or tiles) must be sufficiently large to provide an efficient the processing time/setup time ratio, yet sufficiently small to enable a plurality of processors to operate simultaneously within available resources. Moreover, concurrent processing of the same image on multiple platforms is desired because sequential processing leads to higher memory use on the host platform. The above-described constraints result in different stripe sizes being preferred on different processing platforms.

According to one embodiment, a mechanism is provided to perform concurrent processing of different image stripe sizes at different processing platforms. In the following description, for the purposes of explanation, numerous specific details are set forth to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Throughout this document, terms like “logic”, “component”, “module”, “engine”, “model”, “calculator” and the like, may be referenced interchangeably and include, by way of example, software, hardware, and/or any combination of software and hardware, such as firmware. Further, any use of a particular brand, word, term, phrase, name, and/or acronym, should not be read to limit embodiments to software or devices that carry that label in products or in literature external to this document.

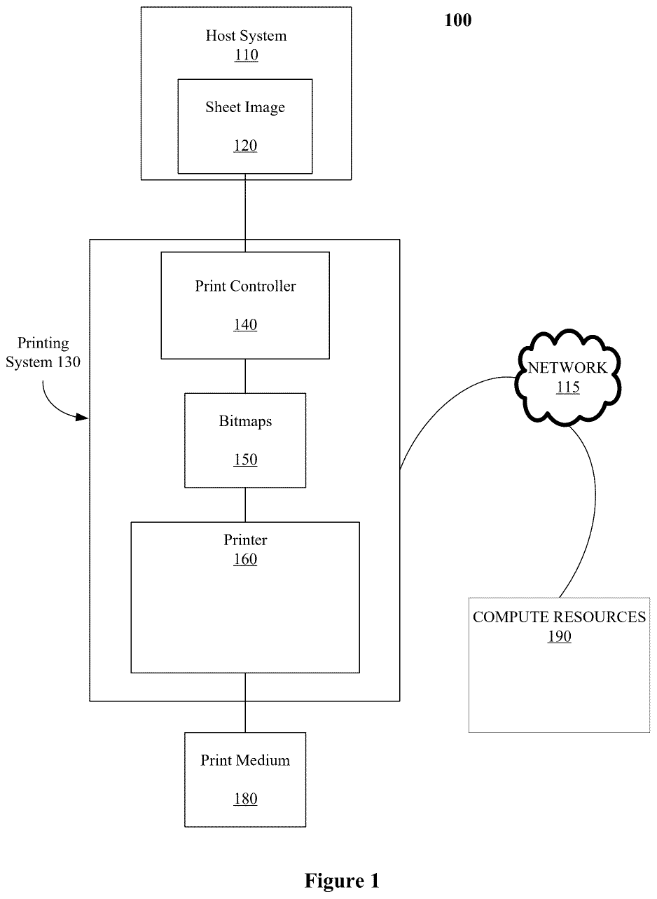

FIG. 1 illustrates one embodiment of a printing system 100. Printing system 100 includes a host system 110, printing system 130 and compute resources 190. In one embodiment, printing system 130 and compute resources 190 communicate via a network 115. However, printing system may have other configurations. For example, in some embodiments compute resources 190 may be implemented in printer printing system 130.

Host system 110 is in communication with the printing system 130 to print a sheet image 120 onto a print medium 180 (e.g., paper) via a printer 160. The resulting print medium 180 may be printed in color and/or in any of a number of gray shades, including black and white (e.g., Cyan, Magenta, Yellow, and black, (CMYK)). The host system 110 may include any computing device, such as a personal computer, a server, cloud infrastructure, or even a digital imaging device, such as a digital camera or a scanner.

The sheet image 120 may be any file or data that describes how an image on a sheet of print medium 180 should be printed. For example, the sheet image 120 may include PostScript data, Printer Command Language (PCL) data, and/or any other printer language data. The print controller 140 processes the sheet image to generate a bitmap 150 for printing to the print medium 180 via the printer 160.

The printing system 130 may be a high-speed printer operable to print relatively high volumes (e.g., greater than 100 pages per minute). The print medium 180 may be continuous form paper, cut sheet paper, and/or any other tangible medium suitable for printing. The printing system 130, in one generalized form, includes the printer 160 having one or more print engines to present the bitmap 150 onto the print medium 180 via marking material (e.g., toner, ink, coatings, etc.) based on the sheet image 120.

Print controller 140 and printer 160 may both be implemented in the same printing system 130 or implemented separately and coupled together. In another embodiment, print controller 140 may be implemented in host system 110 and coupled to printer 160. Print controller 140 may be any system, device, software, circuitry and/or other suitable component operable to transform the sheet image 120 for generating the bitmap 150 in accordance with printing onto the print medium 180. In this regard, the print controller 140 may include processing and data storage capabilities. Compute resources 190 are in communication with printing system 130 to provide satellite processing resources to process bitmap 150.

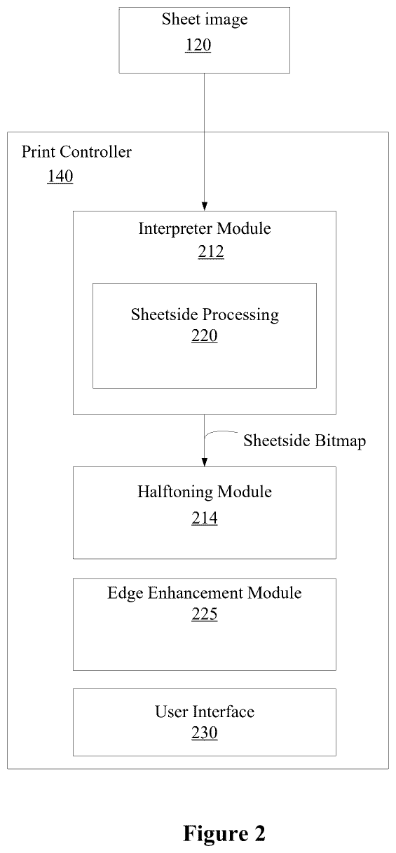

FIG. 2 illustrate one embodiment of a print controller 140. As shown in FIG. 2, print controller 140 (e.g., DFE or digital front end), in its generalized form, includes interpreter module 212, halftoning module 214, sheetside processor 220, and edge enhancement module 225. Interpreter module 212 is operable to interpret, render, rasterize, or otherwise convert images (e.g., raw sheetside images such as sheet image 120) of a print job into sheetside bitmaps.

The sheetside bitmaps generated by interpreter module 212 are each a 2-dimensional array of pixels representing an image of the print job (e.g., a contone image or Continuous Tone Image (CTI)), also referred to as full sheetside bitmaps. The 2-dimensional pixel arrays are considered “full” sheetside bitmaps because the bitmaps include the entire set of pixels for the image. Interpreter module 212 is operable to interpret or render multiple raw sheetsides concurrently so that the rate of rendering substantially matches the rate of imaging of production print engines.

Halftoning module 214 is operable to represent the sheetside bitmaps as halftone patterns of ink. For example, halftoning module 214 may convert the pixels to halftone patterns of CMYK ink for application to the paper. A halftone design may comprise a pre-defined mapping of input pixel gray levels to output drop sizes based on pixel location. Drop size selection based on the contone value of a single pel is referred to as “Point Operation” halftoning. The drop size selection is based on the contone pel values in the sheetside bitmap. This contrasts with “Neighborhood Operation” halftoning, where multiple pels in the vicinity of the pel being printed are used to determine the drop size. Examples of neighborhood operation halftoning include the well-known error diffusion method.

Edge enhancement module 225 facilitates edge enhancement processing for each pixel in the sheetside bitmap. In one embodiment, edge enhancement processing comprises detecting edge pixels in the sheetside bitmap and performing an edge pixel specific halftoning operation on the detected pixels. Detecting edge pixels may be dependent on multiple pels in the vicinity of the pel being printed. In a further embodiment, edge enhancement module 225 facilitates edge enhancement processing by transmitting data processed at print controller 140 to compute resources 190 for satellite processing (e.g., remote processing or supplemental processing).

According to one embodiment, one or more of interpreter 212, halftoning module 214, or edge enhancement module 225 comprise sheetside processing to perform pipelined parallel asynchronous processing of sheetside images via nested (e.g., two or more) task queue structures via a plurality of processing resources. In such an embodiment, sheetside processing comprises a first processor (e.g., one or more host processors or CPU's) to divide an image into a plurality of stripe image components, determine assignments for each of the plurality of stripe image components to one of a plurality of tile groups, perform a first processing on the stripe image components, assemble the first processed stripe image components into the plurality of tile groups according to the assignments, transmit the plurality of tile groups, receive processed tile groups and assemble the processed tile groups into a processed image. In a further embodiment, sheetside processing comprises a second processor (e.g., one or GPUs) to perform a second processing on each of the plurality of tile groups to generate processed tile groups. Resulting technical benefits include efficient processing of an image to produce a processed image.

Although illustrated as being included within interpreter module 212, other embodiments may implement sheetside processing 220 as a separate component. Still other embodiments may implement sheetside processing 220 within halftoning module 214, within interpreter module 212 and/or within edge enhancement module 225, depending on processing requirements within halftoning module 214, interpreter module 212 and edge enhancement module 225. As used herein, sheetside processing 220 comprises one or more host processors (e.g., one or more first processors) and compute resources 190 comprises one or more satellite processors (e.g., one or more second processors).

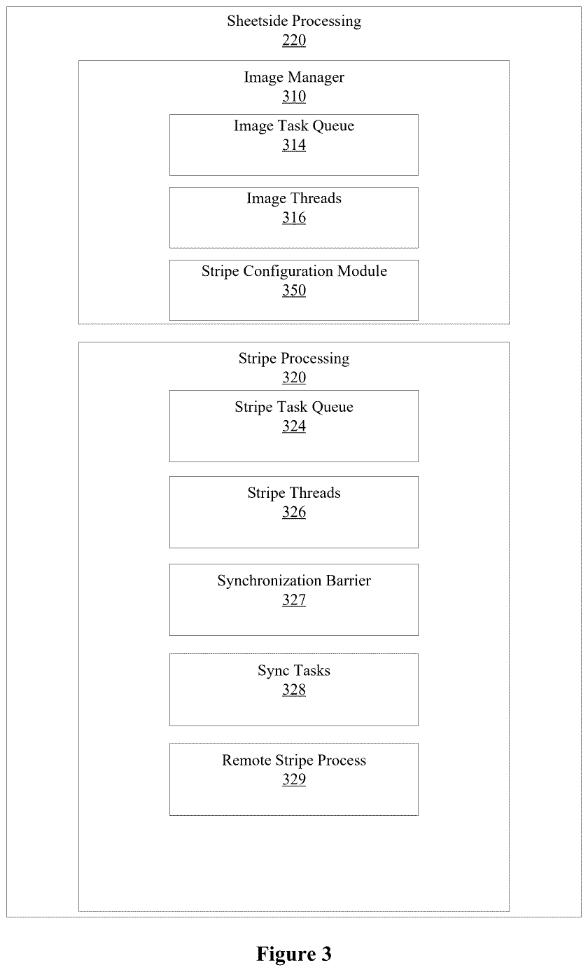

FIG. 3 illustrates one embodiment of a sheetside processing 220, including an image manager 310 and a stripe processing 320. According to one embodiment, image manager 310 detects page/sheet boundaries of each sheetside image (or image) included in print data and generates an image manager task associated with each sheetside image. In one embodiment, a task represents a function pointer to a function to be processed.

In one embodiment, image manager 310 stores each of the generated image manager tasks (e.g., image task) in an image task queue 314 (e.g., a first task queue) for processing by one of a plurality of image threads 316 (e.g., a first set of processing threads). In one embodiment, image task queue 314 is a first in, first out structure that temporarily stores image manager tasks until the image manager tasks can be processed by image threads 316. Thus, execution of image manager tasks by image threads 316 are initiated in an order received at image task queue 314.

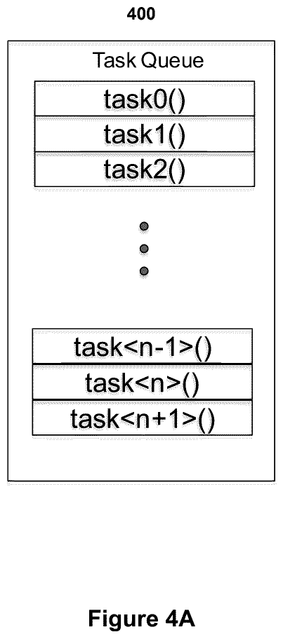

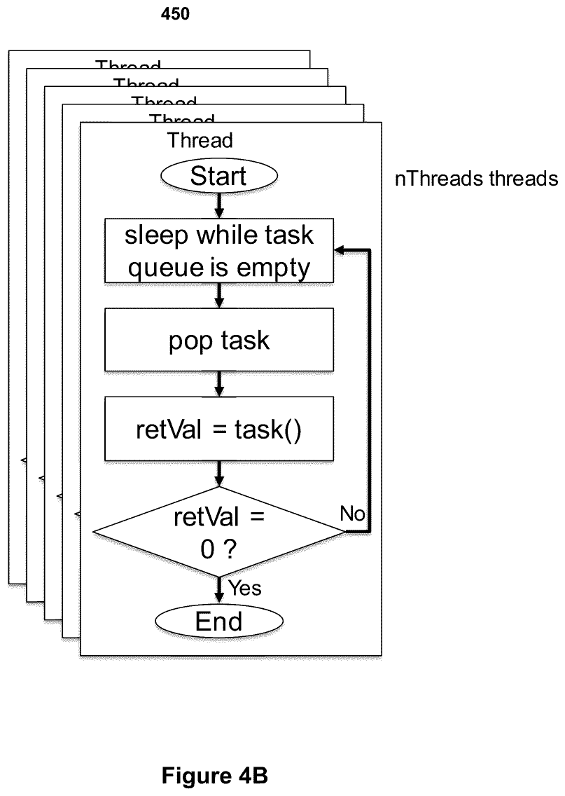

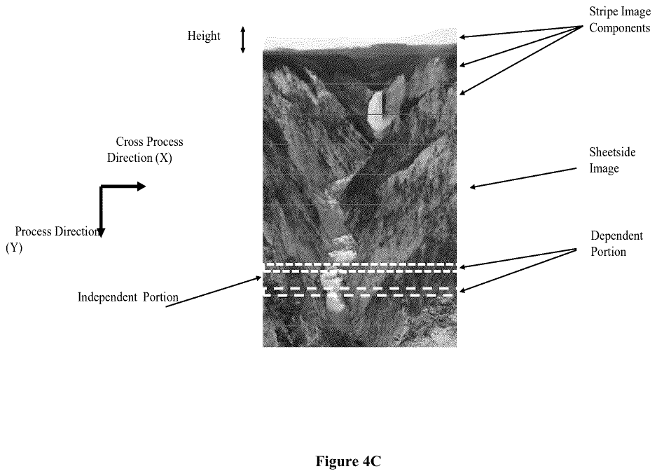

In another embodiment, image manager 310 assigns a single unique image task in image task queue 314 to each sheetside image. As used herein, a FIFO is a method for organizing the manipulation of a data structure (often, specifically a data buffer) where the oldest (first) entry, or “head” of the queue, is processed first. FIG. 4A illustrates one embodiment of a task queue 400 for implementation as image task queue 314. In one embodiment, a thread is a sequence of instructions given to the CPU by a task, program or application.

In a further embodiment, each image thread 316 retrieves an image task from image task queue 314 and calls a function associated with the image task. If no image task is available for processing, an image thread 316 sleeps until a new image task is inserted into image task queue 314. After executing an image task, the image thread 316 accesses image task queue 314 to retrieve the next available image task and repeats the process. FIG. 4B illustrates one embodiment of a plurality of (e.g., n) processing threads 450 for implementation as image threads 316.

According to one embodiment, each image thread 316 is allocated a dedicated set of intermediate image buffers in memory to accommodate the required processing. In such an embodiment, the number of image threads 316 is used to limit a quantity of the intermediate buffer sets that must be allocated. The more image threads 316 that are associated with image task queue 314 will improve processor utilization efficiency, though at the expense of more resource use in the form of intermediate image buffers. Accordingly, use of memory and hardware processing resources may be optimized (e.g., increasing image processing utilization while not exceeding limited resources such as buffer storage in a defined system) for a given hardware configuration by selecting the number of threads in the first task queue.

According to one embodiment, the optimal number of threads in image task queue 314 may be determined based on the amount of memory that must be allocated to each simultaneously processed image, the amount of memory available for the use of a parallel asynchronous image processing engine and the number of hardware processing threads available for use by a parallel image processing engine. Determining and/or selecting the number of threads in the first task queue may be done by host system 110, print controller 140 or sheetside processing 220.

Alternatively, the number of threads may be received from a user interface 230 at print controller 140 corresponding to the aforementioned elements. Alternatively, the number of threads may be stored and/or retrieved from memory corresponding to the aforementioned elements. In one embodiment, image manager 310 sets the number of threads in the first task queue to not exceed a numerical limit.

In one embodiment, each image manager task, when executed by an image thread 316, generates a set of stripe image components and stripe tasks corresponding to an image to which the image task is associated. As used herein, a stripe image component (e.g., a stripe or satellite stripe image component) comprises a group of pixels that are contiguous in memory that have a predefined height (e.g., rows of pixels). A stripe image component allows processing of an image in data chunks and facilitates processing (e.g., parallel processing). In one embodiment, each image manager task generates an ordered set of the plurality of stripe image components resulting in technical benefits that include more efficient subsequent assembling of tile groups.

FIG. 4C illustrates one embodiment of a print image divided into stripes. As shown in FIG. 4C, the print image comprises a sheetside image divided into stripe image components having independent and dependent portions.

Stripe processing 320 receives each set of stripe image components and stripe tasks and stores the stripe tasks in a stripe task queue 324 (e.g., second task queue) for processing by stripe threads 326 (e.g., second set of processing threads). In such an embodiment, stripe task queue 324 is a collection of distinct task queues such that there is a unique stripe task queue 324 for each image thread 316 associated with the image task queue 314.

In a further embodiment, stripe task queue 324 is similar to image task queue 314 (e.g., implemented using task queue 400 shown in FIG. 4A). In a further embodiment, stripe threads 326 are implemented using processing threads 450 structure shown in FIG. 4B and operate as worker threads to process the stripe image components.

According to one embodiment, stripe task queue 324 have a nested relationship with image task queue 314. In such an embodiment, each of the stripe tasks stored at stripe task queue 324 for execution by stripe threads 326 correspond to an image task being executed by an image thread 316. Thus, the image thread 316 executing the image task may be referred to as a “parent” thread, while stripe threads 326 executing the stripe tasks may be referred to as a “child” thread.

In one embodiment, the stripe tasks are processed in parallel by stripe threads 326. Similar to image manager tasks discussed above, execution of stripe tasks by stripe threads 326 are initiated in an order received at stripe task queue 324. However, due to the parallel processing, the stripe tasks are not guaranteed to be completed in order. Accordingly, stripe processing 320 performs thread synchronization tasks, which have been enqueued after all stripe processing tasks within the sheetside by image threads 316, one for each of the stripe processing threads within the stripe task queue 324. In such an embodiment, an image task creates a synchronization barrier 327 after enqueueing all of the stripe tasks necessary to process the image.

In one embodiment, synchronization barrier 327 provides a barrier at which each stripe thread 326 that finishes processing must wait until all other stripe threads 326 (e.g., stripe threads corresponding to the same image or the same set of stripe threads) reach the synchronization barrier 327. Thus, synchronization barrier 327 determines that the processing of the first set of stripe tasks is complete. In such an embodiment, synchronization barrier 327 is created for the corresponding number of stripe threads 326 or the number of stripe threads 326 plus one (e.g., nthreads+1).

In a further embodiment, the image thread 316 enqueues one synchronization task for each stripe thread and then itself executes a synchronization task, so that ultimately together nthreads+1 synchronization tasks are executed, which is the number that the barrier implements in order to release all the threads. In a further embodiment, image manager 310 transmits a “image done” message to sheet side processing 220 upon completion of synchronization to indicate that processing of all stripe components within the full sheet side has been completed.

Once synchronization barrier 327 has been created, stripe processing 320 generates synchronization (or sync) tasks that are inserted into stripe task queue 324. In one embodiment, the number of sync tasks 328 inserted into stripe task queue 324 equals the number of stripe threads 326 (e.g., nthreads). In yet a further embodiment, stripe processing 320 may also generate metadata structures prior to performing the thread synchronization process.

Examples of image processing include halftoning, edge enhancement, compression, decompression, and color correction. Image processes may have many processing options (e.g., selected halftone designs, transfer functions, thresholds, targets and/or conditional processing), which can be different from one image to another with the processing option included in the corresponding metadata structures. For edge processing, the processing options may fine tune the tests used to determine which pixels are designated as edge pixels. These processing options can also determine the transfer function applied to the edge pixels before re-halftoning them using the edge enhancement halftone design. Edge enhancement processing options can also fine tune the algorithm used to detect different types of edge pixels, such as light text on a dark background, dark graphics on a light background, etc.

Upon retrieving a sync task 328 from stripe task queue 324, each stripe thread 326 that finishes processing waits once encountering synchronization barrier 327. Once the synchronization barrier 327 has been satisfied (e.g., determine that corresponding stripe threads 326 have finished processing), the set of processed stripe image components are returned to image manager 310 and an image thread 316, which is itself awaiting synchronization, may then send the image complete message to the client process, and then retrieve and process a subsequent image task in image task queue 314, if any are remaining. As a result, the image thread 316 may process the next image task by generating another set of stripe image components to be processed by stripe processing 320, as discussed above.

According to one embodiment, image manager 310 may process images in parallel. In such an embodiment, one or more image threads 316 may process one or more subsequent image tasks stored in image task queue 314 during processing of first image. Thus, two or more sets of stripe image components may be processed by stripe threads 326 at any given time. In a further embodiment, an execution priority of the stripe threads 326 are configured high relative to that of image threads 316 to ensure that sheetsides are finished as expeditiously as possible, once they are started, given available hardware processors.

In a further embodiment, each image manager task, when executed by an image thread 316, also generates a plurality of satellite stripe tasks in addition to the plurality of stripe tasks. In such an embodiment, each satellite stripe task indicates additional processing to be performed on the processed stripe image components at compute resources 190. Accordingly, remote stripe process 329 is implemented to transmit the satellite stripe tasks and processed stripe image components to compute resources 190 for the additional processing.

As discussed above, the additional processing may comprise edge enhancement processing. In one embodiment, a stripe thread 326 makes a processed stripe image component available for transmission to compute resources 190 once stripe image processing has been completed. In such an embodiment, remote stripe process 329 retrieves a remote process identifier from compute resources 190. In a further embodiment, remote stripe process 329 inserts the remote process identifier and information regarding a quantity of stripe tasks and satellite stripe tasks associated with an image manager task that are to be processed within a metadata structure, which is transmitted to compute resources 190.

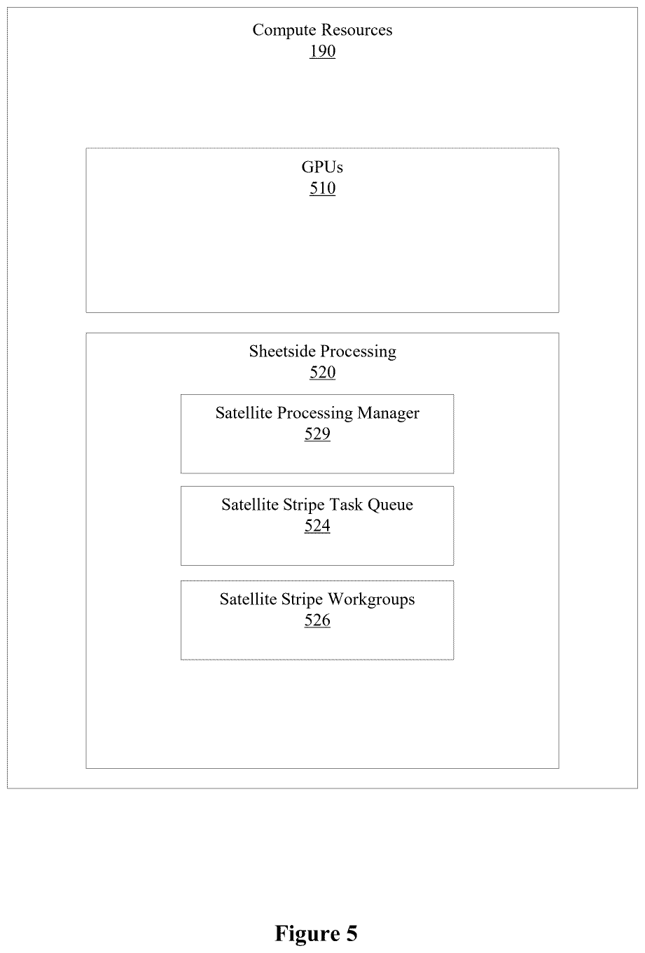

FIG. 5 illustrates one embodiment of compute resources 190. According to one embodiment, compute resources 190 receives the satellite stripe tasks and the processed stripe image components (e.g., first processed stripes), stores the satellite stripe tasks within a set of task queues and processes each of the first processed stripe image components based on the satellite stripe tasks to generate a plurality of second processed stripe image components (e.g., second processed stripes). In a further embodiment, each satellite stripe task queue 524 corresponds to one of the image manager tasks.

As shown in FIG. 5, compute resources 190 comprises one or more graphics processing units (GPUs) 510 (e.g., one or more second processors) and sheetside processing 520 (e.g., satellite sheetside processing). According to one embodiment, GPUs 510 comprise a plurality of compute units each having array of processors that are implemented to perform the satellite processing on the stripe image components. Sheetside processing 520 includes a satellite processing manager 529 to receive the metadata structure including the satellite stripe tasks and the processed stripe image components, and store the satellite stripe tasks in a satellite stripe task queue 524 (e.g., a third set of task queues) for processing by a plurality of satellite stripe workgroups 526. In such an embodiment, satellite stripe task queue 524 is a collection of distinct task queues such that there is a unique satellite stripe task queue 524 for each image thread 316 associated with the image task queue 314. In a further embodiment, satellite stripe task queue 524 is similar to image task queue 314 and stripe task queue 324 (e.g., implemented using task queue 400 shown in FIG. 4A). Satellite stripe workgroups 526 manage the processing of the processed stripe image components at GPUs 510. In one embodiment, a workgroup is a group of threads that exist on the GPUs 510 at the same time and on the same compute unit and may be executed together.

In one embodiment, a satellite stripe workgroup 526 analyzes a current stripe image component (e.g., a previously processed stripe) and determines whether a portion of the stripe image component (e.g., a portion of the previously processed stripe) requires data from a prerequisite stripe image component (e.g., a prerequisite first processed stripe) for processing. This may be determined based on information in the metadata structures. If so, that portion is designated a dependent portion of the current stripe image component. If not, that portion is designated an independent portion (e.g., not a dependent portion).

When the data from the prerequisite stripe image component is available, the satellite stripe workgroup 526 processes the dependent portion of the current stripe image component. Otherwise, satellite stripe workgroup 526 waits to receive the prerequisite stripe image component before processing the dependent portion. As used herein, the dependent portion is a portion of a current stripe image component whose processing depends on data in a prerequisite stripe image component. Further as used herein, an independent portion of the stripe image component is a portion of a stripe image component whose processing does not depend on data in another stripe image component. Satellite stripe workgroup 526 proceeds to process independent portions of the current stripe image components without waiting for the prerequisite stripe image component being available (e.g. the independent portions are immediately processed).

As mentioned above, some types of image processing (e.g., halftoning and/or edge enhancement) may have a dependency on vicinity pel data and as a result may have at least one dependent portion and one independent portion. Subsequently, the satellite stripe workgroup 526 processes the dependent portion of the current stripe image component when the prerequisite stripe image component is available.

Once processed, the processed current stripe image component data is transmitted to print controller 140 (e.g., via satellite processing manager 529 and satellite processing manager 529). In a further embodiment, a portion of a stripe image component is determined to be a dependent portion if the portion is located adjacent a top or bottom of a stripe image component. As described herein, the processing of the portions results in a technical benefit of efficient processing while managing the portion dependencies.

According to one embodiment, the satellite stripe workgroup 526 determines whether the current stripe image component is a final stripe image component. If so, the satellite stripe workgroup 526 generates a satellite done message upon determining that the current stripe image component is the final stripe image component. Otherwise, the next stripe image component is processed as the current stripe image component.

In one embodiment, the satellite done message is received at the associated image thread 316. In such an embodiment, a wait state is implemented to prevent an image thread 316 from retrieving another task until all associated processed satellite stripe image components have been received. In a further embodiment, the wait state is cleared once the final stripe image component has been received from satellite stripe workgroup 526, resulting in an image done message being transmitted from the image thread 316 to image manager 310.

The image done message indicates that the final stripe image component for the image has been processed and that the image task is complete. Subsequently, image thread 316 is permitted to retrieve another image to process. In an alternative embodiment, the satellite done message is received at image manager 310 directly from sheetside processing 520 as the image done message, which precludes having to implement the wait state.

According to one embodiment, satellite stripe task queue 524 also has a nested relationship with image task queue 314. In such an embodiment, each of the stripe tasks are stored at satellite stripe task queue 524 for execution by a satellite stripe workgroup 526 corresponding to an image task being executed by an image thread 316. In a further embodiment, the satellite stripe tasks are processed in parallel by stripe threads 326. Similar to image manager tasks discussed above, execution of stripe tasks by stripe threads 326 are initiated in an order received at stripe task queue 324.

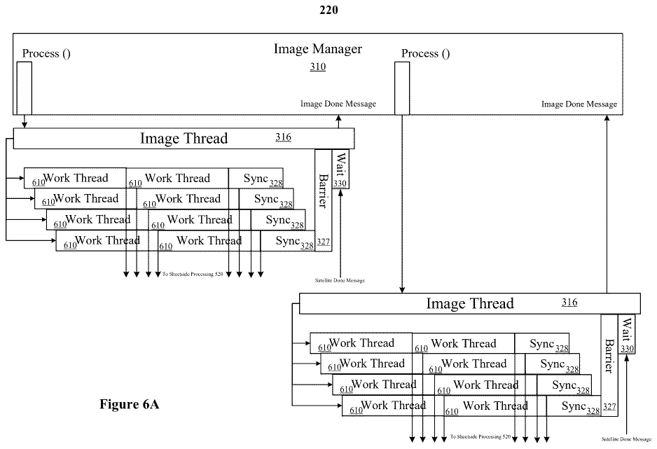

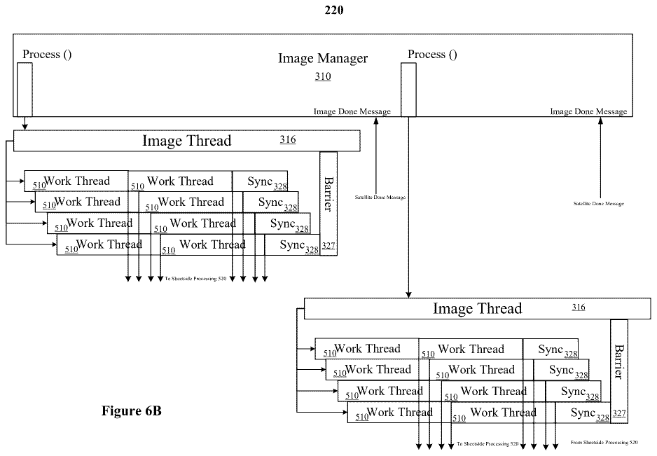

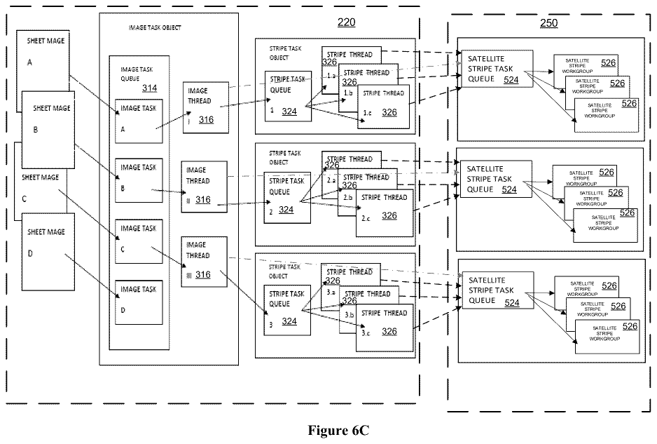

FIG. 6A illustrates another embodiment of a sheetside processing 220. As shown in FIG. 6A, an image thread 316 is processing multiple sheetsides via stripe processing worker threads 610 as time progresses left to right. Additionally, corresponding synchronization barrier 327 and sync tasks 328 are included to perform synchronization. According to one embodiment, each work thread 610 associated with image thread 316 transmits its processed data to sheetside processing 520 for additional processing. Subsequently, wait state is activated to prevent image threads 316 from retrieving another image from image task queue 314 until the last processed satellite stripe component data has been received from sheetside processing 520. The image thread 316 transmits the “image done” message to the image manager 310 (e.g., sheetside processing 220 or halftoning module 214) once synchronization has been completed and the wait state has been cleared. In one embodiment, the “image done” message includes metadata describing the work that has been performed. FIG. 6B illustrates yet another embodiment of a sheetside processing 220. In this embodiment, wait state is not implemented since the satellite done message is received directly at the client threads from sheetside processing 520 as the image done message.

FIG. 6C illustrates a process flow for sheetside processing 220 and sheetside processing 520. As shown in FIG. 6C, there is a one-to-one correspondence of a sheet image to an image task and a separate one-to-one correspondence between image threads 316 and stripe task queues 324 and image threads 316 and satellite stripe task queues 524. Further, an image task D waits to be executed by an image thread 316 after another image task has completed. However, this may not be required in other embodiments.

In one embodiment, a remote process identifier is used to coordinate processing at sheetside processing 220 (e.g., host processing) and at sheetside processing 520 (e.g., remote processing). In that embodiment, the remote process identifier includes an identification of the image (e.g., an image identifier) that is to be remotely processed. Image manager 310 within sheetside processing 220 creates a remote process identifier corresponding to an image and transmits it to sheetside processing 520. Satellite processing manager 529 within sheetside processing 520 receives the remote process identifier and allocates space for remote processing resources (e.g., memory, threads and/or workgroups) for use when processing the image identified in the remote process identifier.

When the allocation is complete, satellite processing manager 529 transmits a processor resource space allocation complete message to imaging manager 310 that references the remote process identifier. Imaging manager 310 receives the processor resource space allocation complete message and initiates generation of stripe tasks and satellite stripe tasks for the image (e.g., by placing image manager tasks in the image task queue) that include references to the remote process identifier (e.g., referenced in the associated metadata). In other words, host processor (e.g., the first processor) transmits a remote process identifier (e.g., a processor space allocation request) to the satellite processor (e.g., the second processor) prior to sending the corresponding plurality of first processed stripes to the satellite processor (e.g., second processor).

Stripe processing 320 within sheetside processing 220 processes the stripe tasks to generate processed stripe tasks that include the remote process identifier (e.g., referenced in the associated metadata). Sheetside processing 520 processes the satellite stripe tasks to generate processed satellite stripes tasks that include the remote process identifier (e.g., referenced in the associated metadata). With each new image, the above steps are repeated so that each image has a corresponding unique remote process identifier. The previously mentioned satellite done messages and image done messages may also include the corresponding remote process identifier and/or pointers to one or more corresponding metadata structures.

In another embodiment, imaging manager 310 waits to initiate the generation of stripe tasks and satellite stripe tasks for an image (e.g., initiate the generation of stripe tasks and satellite stripe tasks by placing the image manager tasks in the image task queue) until after receiving the processor resource space allocation complete message corresponding to the image.

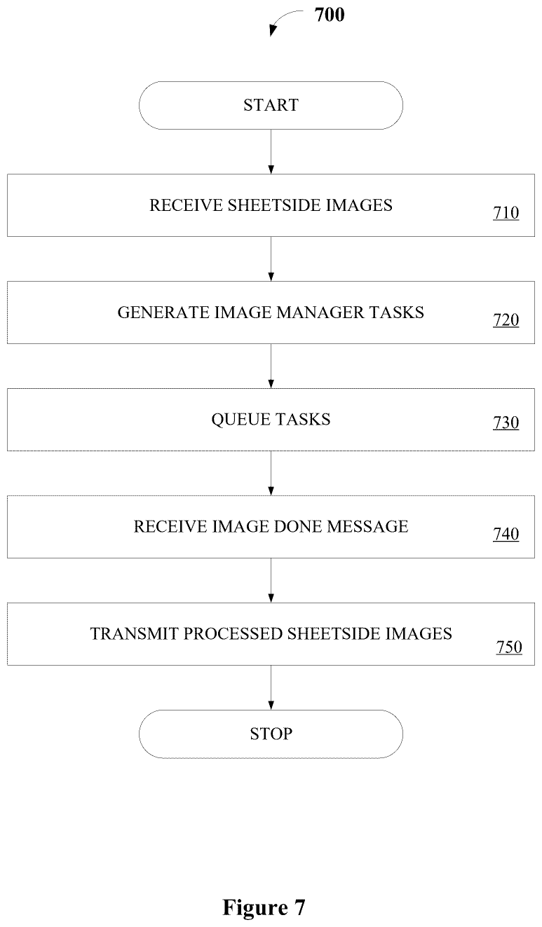

FIG. 7 is a flow diagram illustrating one embodiment of a process 700 for performing sheetside image processing. Process 700 may be performed by processing logic that may comprise hardware (e.g., circuitry, dedicated logic, programmable logic, etc.), software (such as instructions run on a processing device), or a combination thereof. In one embodiment, process 700 may be performed by sheetside processing 220. In a different embodiment, process 700 may be alternatively or additionally performed by halftone module 214. The process 700 is illustrated in linear sequences for brevity and clarity in presentation; however, it is contemplated that any number of them can be performed in parallel, asynchronously, or in different orders. For brevity, clarity, and ease of understanding, many of the details discussed with reference to FIGS. 1-6 are not discussed or repeated here.

Process 700 begins at processing block 710, where sheetside images are received in print data to be printed. At processing block 720, image manager tasks and stripe image components are generated for each sheetside image. At processing block 730, the image manager tasks are stored (e.g., inserted) into an image task queue and the stripe image components are stored. Subsequently, each of the image manager tasks are processed by one of a plurality of image threads 316 (e.g., first processing threads). As discussed above, the processing of each image manager task is executed by an image thread 316 to generate a set of stripe tasks, satellite stripe tasks and stripe components associated with the image.

At processing block 740, one or more “image done” messages may be received, indicating a completion of the processing of one or more associated images. At processing block 750, the processed sheetside images are transmitted for further processing. In one embodiment, the processed sheetside images may be forwarded for halftoning at halftoning module 214. In such an embodiment, the processing that is performed may be a decompression of compressed sheetsides, which are subsequently forwarded for halftoning. In another embodiment, the processed images may be decrypted sheetside images that are forwarded for decompression image processing, where the sheetside images are again processed via process 700.

### Non-Uniform Stripe Image Component Processing

As discussed above, print controller 140 may process stripe image components having a different stripe height than processed stripe image components to be processed at GPUs 510 due to a latency of the interconnect between print controller 140 and compute resources 190. Typically, GPUs 510 operates most efficiently with stripe image components having larger stripe heights in order to minimize data transfer latency per data volume.

According to one embodiment, image manager includes a stripe configuration module 350 implemented to determine assignments of each stripe image component to one of a plurality of stripe (or tile) groups and to assemble processed stripe image components (e.g., once processed at stripe processing 310) into the plurality of tile groups according to the assignments. In a further embodiment, remote stripe process 329 transmits each assembled tile group to compute resources 190 for satellite processing. In another embodiment, the plurality of tile groups comprise second processing tasks (e.g., satellite stripe tasks) and the second processing is based on the second processing tasks. Resulting technical benefits include improved resource utilization with threaded processors.

In one embodiment, stripe configuration module 350 determines tile group assignments based on stripe image height and/or stripe image group height resulting in technical benefits that include optimizing resources and/or processing time at print controller 140 and compute resources 190. In such an embodiment, each tile group height comprises a multiple of the stripe height of a stripe image component based on the processing capabilities of GPUs 510.

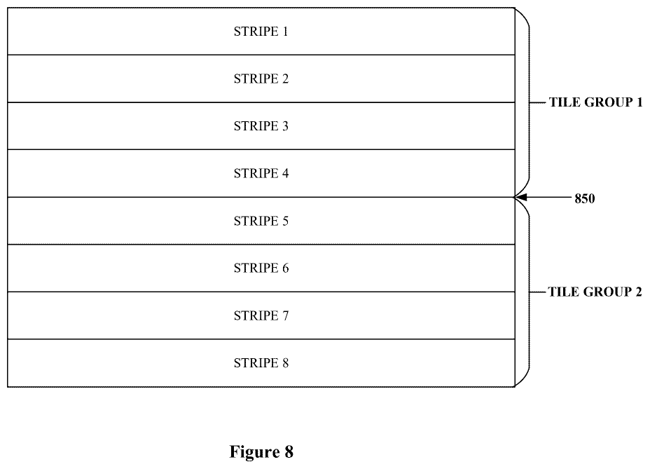

FIG. 8 illustrates one embodiment stripe image components (e.g., stripe 1-stripe 8) assembled into tile groups. As shown in FIG. 8, stripe 1-stripe 4 are assembled into a tile group 1, while stripe 5-stripe 8 are assembled into a tile group 2. In one embodiment, tile boundary 850 represents a boundary between stripe 4 in tile in group 1 and stripe 5 in tile group 2.

According to one embodiment, image manager 310 receives input color sheetside image parameters. In such an embodiment, image manager 310 processes the sheetside image according to the following parameters:

$$L = image height \\ {L}_{S} = stripe image ( stripe image component ) height ; and \\ {L}_{T} = k * {L}_{S} = compute resources 190 ( or satellite ) \\ group height or tile group height where k is an integer$$

In one embodiment, stripe configuration module 350 identifies the stripe image and tile group height sheetside image parameters upon receiving a sheetside image in order to compute a number count of stripe color image components (e.g., N_{S}=L/L_{S}) and tile groups (N_{T}=L/L_{T}). In a further embodiment, the sheetside image parameters are constant values for a particular print controller 140 and compute resources 190 configuration. In another embodiment, the height of the tile group is greater than twice the height of the stripe components. Resulting technical benefits include optimizing processing efficiency for different processors that have significantly different capabilities for image heights.

As discussed above, image manager 310 receives a print image and generates a set of stripe image components and associated stripe tasks to divide the print image. Subsequently, stripe configuration module 350 generates a stripe image component set (e.g., S={s₁, s₂, . . . , s_{N}_{_{S}}}) during generation of the stripe tasks and satellite stripe tasks and reorders the set for processing. In one embodiment, the stripe tasks and satellite stripe tasks are inserted in stripe task queue based on the set order. In a further embodiment, stripe processing 320 may process stripe image components in any order determined to be optimal. In such an embodiment, stripe processing 320 may process the stripe image components in a random order.

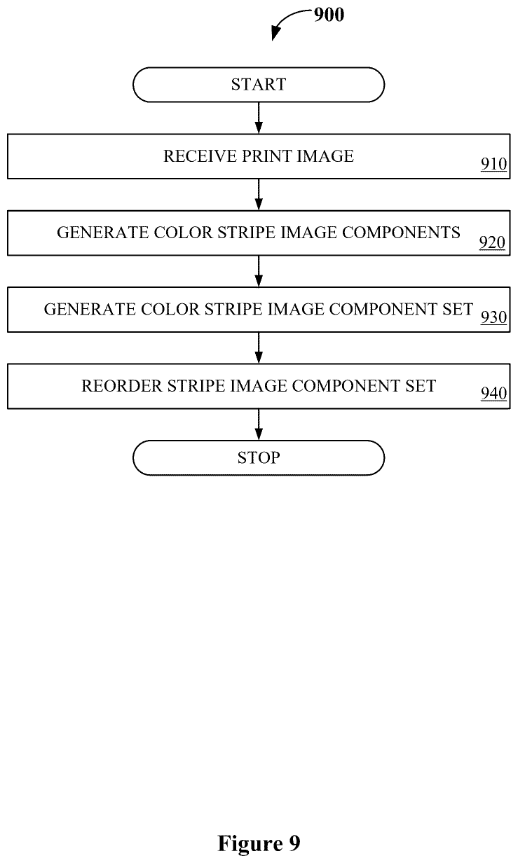

FIG. 9 is a flow diagram illustrating one embodiment of a process 900 for generating a set of stripe image components. Process 900 may be performed by processing logic that may comprise hardware (e.g., circuitry, dedicated logic, programmable logic, etc.), software (such as instructions run on a processing device), or a combination thereof. In one embodiment, process 900 may be performed by image manager 310. The process 900 is illustrated in linear sequences for brevity and clarity in presentation; however, it is contemplated that any number of them can be performed in parallel, asynchronously, or in different orders. For brevity, clarity, and ease of understanding, many of the details discussed with reference to FIGS. 1-8 are not discussed or repeated here.

Process 900 begins at processing block 910, where a print image is received. At processing block 920, stripe image components are generated. At processing block 930, a set of stripe image components are generated. At processing block 940, the_stripe image components within the set are reordered for processing.

Stripe configuration module 350 also generates tile groups of stripe image components for initial (or first) processing via stripe tasks. In one embodiment, the first processing comprises performing a decompression operation on each stripe image component via an associated stripe task.

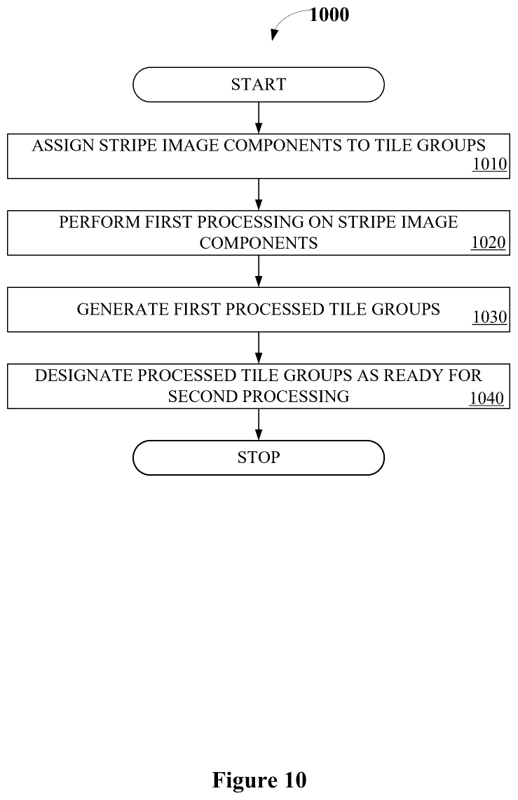

FIG. 10 is a flow diagram illustrating one embodiment of a process 1000 for generating processed tile groups of stripe image components. Process 1000 may be performed by processing logic that may comprise hardware (e.g., circuitry, dedicated logic, programmable logic, etc.), software (such as instructions run on a processing device), or a combination thereof. In one embodiment, process 1000 may be performed by image manager 310. The process 1000 is illustrated in linear sequences for brevity and clarity in presentation; however, it is contemplated that any number of them can be performed in parallel, asynchronously, or in different orders. For brevity, clarity, and ease of understanding, many of the details discussed with reference to FIGS. 1-9 are not discussed or repeated here.

Process 1000 begins at processing block 1010, where stripe image components are assigned to tile groups. At processing block 1020, first processing (e.g., decompression) is performed on stripe image components (e.g., via execution of associated stripe tasks). At processing block 1030, first processed tile groups are generated. In one embodiment, a processed tile group is generated by assembling first processed stripe image components into the tile group based on the tile group assignments. At processing block 1040, the processed tile groups are designated as ready for second processing (e.g., halftoning) at compute resources.

In one embodiment, remote stripe process 329 transmits first processed tile groups of processed stripe image components as satellite tile groups, as well as corresponding satellite stripe tasks to compute resources 190 for the additional processing by sheetside processing 520. In this embodiment, sheetside processing 520 generates satellite processing resource groups and that are implemented to generate satellite processed tile groups.

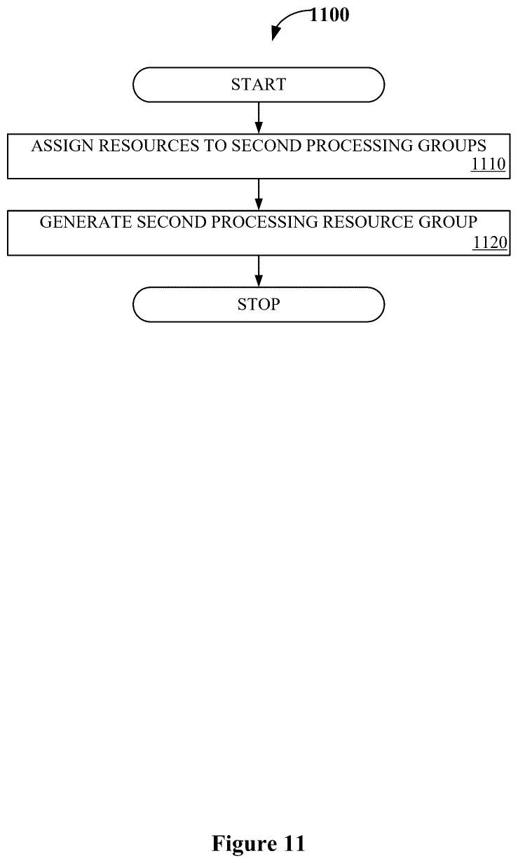

FIG. 11 is a flow diagram illustrating one embodiment of a process 1100 for generating satellite processing resource groups. Process 1100 may be performed by processing logic that may comprise hardware (e.g., circuitry, dedicated logic, programmable logic, etc.), software (such as instructions run on a processing device), or a combination thereof. In one embodiment, process 1100 may be performed by sheetside processing 520. The process 1100 is illustrated in linear sequences for brevity and clarity in presentation; however, it is contemplated that any number of them can be performed in parallel, asynchronously, or in different orders. For brevity, clarity, and ease of understanding, many of the details discussed with reference to FIGS. 1-10 are not discussed or repeated here.

Process 1100 begins at processing block 1110, where resources are assigned to perform satellite processing (or satellite resource group) on each of the received satellite tile groups. At processing block 1120, a satellite processing resource group is generated. In one embodiment, the satellite processing resource group is generated by assembling processing resources according to the satellite processing resource group assignment. In such an embodiment, one or more satellite stripe workgroups 526 are assigned and assembled as the satellite processing resource group to execute the satellite stripe tasks associated with satellite stripe image components within each satellite tile group. In one embodiment, the satellite processing resource group includes halftone threshold arrays which are tiled to match the height of the satellite tile groups. Resulting technical benefits includes optimizing processing efficiency due to the matched heights.

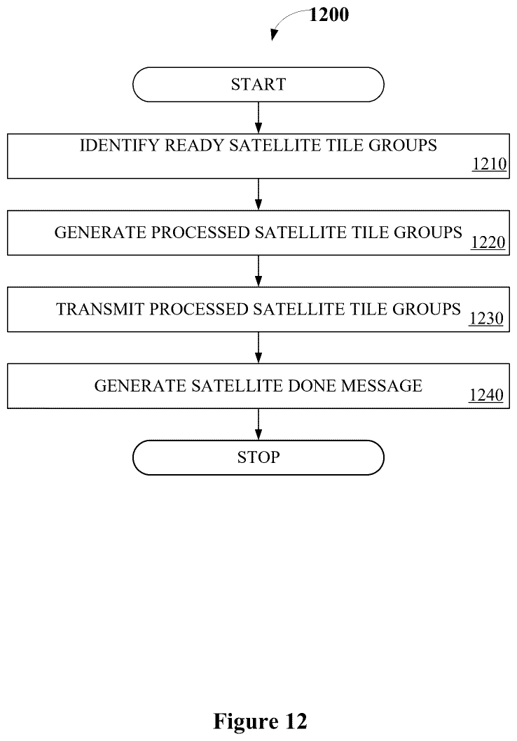

FIG. 12 is a flow diagram illustrating one embodiment of a process 1200 for generating second processed tile groups. Process 1200 may be performed by processing logic that may comprise hardware (e.g., circuitry, dedicated logic, programmable logic, etc.), software (such as instructions run on a processing device), or a combination thereof. In one embodiment, process 1200 may be performed by sheetside processing 520. The process 1200 is illustrated in linear sequences for brevity and clarity in presentation; however, it is contemplated that any number of them can be performed in parallel, asynchronously, or in different orders. For brevity, clarity, and ease of understanding, many of the details discussed with reference to FIGS. 1-11 are not discussed or repeated here.

Process 1200 begins at processing block 1210, where ready satellite tile groups are identified. A resulting technical advantage is that second processing is guided to follow a proper order (e.g., second processing is initiated subsequent to a completion of the assembling of the tile groups and/or the order of second processing of a tile group is based on the order of completion of assembly.). At processing block 1220, second processing (e.g., halftoning) is performed on the ready satellite tile groups to generate processed satellite tile groups. In one embodiment, the processed satellite tile groups are generated by applying the satellite processing resource group (e.g., halftone designs or halftone threshold arrays) to the satellite tile groups. At processing block 1230, the processed satellite tile groups are transmitted. At processing block 1240, a satellite done message is generated. In one embodiment, process 1200 (second processing) may be performed in parallel with process 1000 (first processing) resulting in technical benefits that include increased processing efficin

As discussed above, the satellite done message is received at an image thread 316 indicating that processing of all satellite stripe image components in the satellite tile groups has been completed. Accordingly, the processed satellite tile groups are assembled into a processed image. As mentioned above, an image done is ultimately transmitted indicating that processing of an image has been completed. The processed image is made available (e.g., via transmitting) for the printing process.

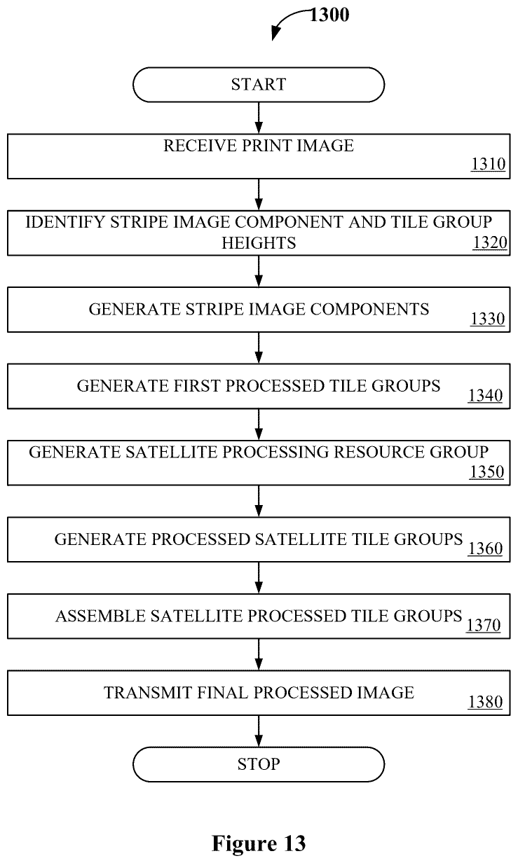

FIG. 13 is a flow diagram illustrating one embodiment of non-uniform stripe image component process 1300. Process 1300 may be performed by processing logic that may comprise hardware (e.g., circuitry, dedicated logic, programmable logic, etc.), software (such as instructions run on a processing device), or a combination thereof. In one embodiment, process 1300 may be performed by sheetside processing 220 and sheetside processing 520. The process 1300 is illustrated in linear sequences for brevity and clarity in presentation; however, it is contemplated that any number of them can be performed in parallel, asynchronously, or in different orders. For brevity, clarity, and ease of understanding, many of the details discussed with reference to FIGS. 1-12 are not discussed or repeated here.

Process 1300 begins at processing block 1310, where a print image is received. At processing block 1320, the stripe image component height and tile group height are identified. At processing block 1330, stripe image components are generated. At processing block 1340, first processed tile groups are generated. Subsequently, the first processed tile groups are transmitted and received at compute resources 190 as satellite tile groups.

At processing block 1350, a satellite processing resource group is generated. At processing block 1360, processed satellite tile groups are generated by applying the satellite processing resource group to the satellite tile groups. At processing block 1370, the processed satellite tile groups are assembled into a processed image. At processing block 1380, the processed image is transmitted, or, otherwise made available, for printing.

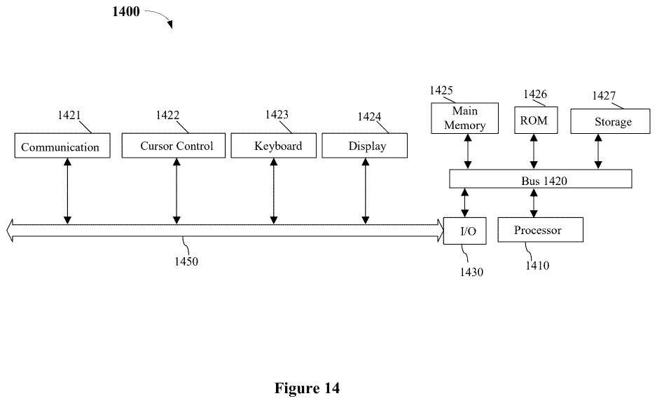

FIG. 14 illustrates a computer system 1400 on which printing host 110, printing system 130, print controller 140 and/or compute resources 190 may be implemented. Computer system 1400 includes a system bus 1420 for communicating information, and a processor 1410 coupled to bus 1420 for processing information.

Computer system 1400 further comprises a random access memory (RAM) or other dynamic storage device 1425 (referred to herein as main memory), coupled to bus 1420 for storing information and instructions to be executed by processor 1410. Main memory 1425 also may be used for storing temporary variables or other intermediate information during execution of instructions by processor 1310. Computer system 1400 also may include a read only memory (ROM) and/or other static storage device 1426 coupled to bus 1420 for storing static information and instructions used by processor 1410.

A data storage device 1427 such as a magnetic disk or optical disc and its corresponding drive may also be coupled to computer system 1400 for storing information and instructions. Computer system 1400 can also be coupled to a second I/O bus 1450 via an I/O interface 1430. A plurality of I/O devices may be coupled to I/O bus 1450, including a display device 1424, an input device (e.g., a keyboard 1423 (e.g., alphanumeric input device) and or a cursor control device 1422). The communication device 1421 is for accessing other computers (servers or clients). The communication device 1421 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system according to embodiments and examples described herein.

Some embodiments pertain to Example 1 that includes a system comprising a first processor to divide an image into a plurality of stripe image component, determine assignments for each of the plurality of stripe image components to one of a plurality of tile groups, perform a first processing on the stripe image components, assemble the first processed stripe image components into the plurality of tile groups according to the assignments, transmit the plurality of tile groups, receive processed tile groups, assemble the processed tile groups into a processed image; and a second processor to perform a second processing on each of the plurality of tile groups to generate processed tile groups.

Example 2 includes the subject matter of Example 1, wherein the second processing of a tile group is initiated subsequent to a completion of assembling of the tile group.

Example 3 includes the subject matter of Examples 1 and 2, wherein the order of second processing of a tile group is based on the order of completion of assembly.

Example 4 includes the subject matter of Examples 1-3, wherein determining assignments is based on a height of a tile group.

Example 5 includes the subject matter of Examples 1-4, wherein the second processor further to generate second processing resource group with a height that matches the height of the tile group; and second processing comprises applying the second processing resource group to a tile group.

Example 6 includes the subject matter of Examples 1-5, wherein the second processing resource group is a halftone threshold array.

Example 7 includes the subject matter of Examples 1-6, wherein the height of the tile group is greater than twice a height of the stripe image components.

Example 8 includes the subject matter of Examples 1-7, wherein the first processor to generate an ordered set of the plurality of stripe image components.

Example 9 includes the subject matter of Examples 1-8, wherein the first processing and the second processing are performed in parallel.

Example 10 includes the subject matter of Examples 1-9, wherein the plurality of tile groups further comprises second processing tasks and the second processing is based on the second processing tasks.

Example 11 includes the subject matter of Examples 1-10, wherein the first processing comprises a decompression operation and the second processing comprises a halftoning operation.

Example 12 includes the subject matter of Examples 1-11, wherein the first processor comprises one or more central processing units (CPUs) and the second processor comprises one or more graphics processing units (GPUs).

Example 13 includes the subject matter of Examples 1-12, further comprising a printer to print the processed image.

Some embodiments pertain to Example 14 that includes at least one computer readable medium having instructions stored thereon, which when executed by one or more processors, cause the processors to divide an image into a plurality of stripe image components, determine assignments for each of the plurality of stripe image components to one of a plurality of tile groups, perform a first processing on the stripe image components, assemble the first processed stripe image components into the plurality of tile groups according to the assignments, perform a second processing on each of the plurality of tile groups to generate processed tile groups and assemble the processed tile groups into a processed image.

Example 15 includes the subject matter of Example 14, wherein the second processing of a tile group is initiated subsequent to a completion of assembling of the tile group.

Example 16 includes the subject matter of Examples 14 and 15, wherein the order of second processing of a tile group is based on the order of completion of assembly.

Example 17 includes the subject matter of Examples 14-16, wherein determining assignments is based on a height of a tile group.

Some embodiments pertain to Example 18 that includes a method comprising dividing an image into a plurality of stripe image components, determining assignments for each of the plurality of stripe image components to one of a plurality of tile groups, performing a first processing on the stripe image components, assembling the first processed stripe image components into the plurality of tile groups according to the assignments, performing a second processing on each of the plurality of tile groups to generate processed tile groups and assembling the processed tile groups into a processed image.

Example 19 includes the subject matter of Example 18, wherein the second processing of a tile group is initiated subsequent to a completion of assembling of the tile group.

Example 20 includes the subject matter of Examples 18 and 19, wherein the order of second processing of a tile group is based on the order of completion of assembly.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A system comprising:
a first processor to:
divide an image into a plurality of stripe image components;
determine assignments for each of the plurality of stripe image components to one of a plurality of tile groups;
perform a first processing on the stripe image components;
assemble the first processed stripe image components into the plurality of tile groups according to the assignments;
transmit the plurality of tile groups;
receive processed tile groups;
assemble the processed tile groups into a processed image; and
a second processor to perform a second processing on each of the plurality of tile groups to generate processed tile groups.

2. The system of claim 1, wherein the second processing of a tile group is initiated subsequent to a completion of assembling of the tile group.

3. The system of claim 2, wherein the order of second processing of a tile group is based on the order of completion of assembly.

4. The system of claim 1, wherein determining assignments is based on a height of a tile group.

5. The system of claim 4, wherein the second processor further to generate second processing resource group with a height that matches the height of the tile group; and second processing comprises applying the second processing resource group to a tile group.

6. The system of claim 5, wherein the second processing resource group is a halftone threshold array.

7. The system of claim 4, wherein the height of the tile group is greater than twice a height of the stripe image components.

8. The system of claim 1, wherein the first processor to generate an ordered set of the plurality of stripe image components.

9. The system of claim 1, wherein the first processing and the second processing are performed in parallel.

10. The system of claim 1, wherein the plurality of tile groups further comprises second processing tasks and the second processing is based on the second processing tasks.

11. The system of claim 1, wherein the first processing comprises a decompression operation and the second processing comprises a halftoning operation.

12. The system of claim 1, wherein the first processor comprises one or more central processing units (CPUs) and the second processor comprises one or more graphics processing units (GPUs).

13. The system of claim 1, further comprising a printer to print the processed image.

14. At least one computer readable medium having instructions stored thereon, which when executed by one or more processors, cause the processors to:
divide an image into a plurality of stripe image components;
determine assignments for each of the plurality of stripe image components to one of a plurality of tile groups;
perform a first processing on the stripe image components;
assemble the first processed stripe image components into the plurality of tile groups according to the assignments;
perform a second processing on each of the plurality of tile groups to generate processed tile groups; and
assemble the processed tile groups into a processed image.

15. The computer readable medium of claim 14, wherein the second processing of a tile group is initiated subsequent to a completion of assembling of the tile group.

16. The computer readable medium of claim 15, wherein the order of second processing of a tile group is based on the order of completion of assembly.

17. The computer readable medium of claim 14, wherein determining assignments is based on a height of a tile group.

18. A method comprising:
dividing an image into a plurality of stripe image components;
determining assignments for each of the plurality of stripe image components to one of a plurality of tile groups;
performing a first processing on the stripe image components;
assembling the first processed stripe image components into the plurality of tile groups according to the assignments;
performing a second processing on each of the plurality of tile groups to generate processed tile groups; and
assembling the processed tile groups into a processed image.

19. The method of claim 18, wherein the second processing of a tile group is initiated subsequent to a completion of assembling of the tile group.

20. The method of claim 19, wherein the order of second processing of a tile group is based on the order of completion of assembly.
